(19) United States
(12) Patent Application Publication
(10) Pub. No.: US 2008/0008227 A1
(43) Pub. Date: Jan. 10, 2008

(54) Temperature sensor fixing apparatus and air conditioner having the same

(75) Inventors: Kyoung-Keun Jang, Yongin-si (KR); Byoung Guk Lim, Suwon-si (KR); Jun Ki Byun, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/653,349

(22) Filed: Jan. 16, 2007

(30) Foreign Application Priority Data
Jul. 10, 2006 (KR) 2006-64549
Jul. 12, 2006 (KR) 2006-65599

(51) Int. Cl. G01K 1/00

(52) U.S. Cl. 374/208

(57) ABSTRACT

A temperature sensor fixing apparatus includes a sensor holder to hold a temperature sensor, and a fixing member inserted into the sensor holder to fix the temperature sensor to the sensor holder. The fixing member includes a first fixing portion to prevent the fixing member from being separated from the sensor holder in an insertion direction of the fixing member, a contact portion to attach the temperature sensor to the sensor holder, and a second fixing portion elastically deformed when it is inserted into the sensor holder and elastically restored to its original state when it protrudes from the sensor holder to prevent the fixing member from being separated from the sensor holder in a direction opposite to the insertion direction. An air conditioner includes the temperature sensor fixing apparatus.

### CROSS-REFERENCE TO RELATED APPLICATIONS

This application claims the benefit under 35 U.S.C. 119 §(a) from Korean Patent Application Nos. 2006-64549, filed Jul. 10, 2006, and 2006-0065599, filed Jul. 12, 2006, in the Korean Intellectual Property Office, the disclosure of which is incorporated herein in their entirety by reference.

### BACKGROUND OF THE INVENTION

1. Field of the Invention

The present general inventive concept relates to a temperature sensor fixing apparatus and an air conditioner having the same, and more particularly, to a temperature sensor fixing apparatus, which stably fixes a temperature sensor in an installed position and has a simple structure, and an air conditioner having the same.

2. Description of the Related Art

Generally, an air conditioner includes a compressor, an outdoor heat exchanger, an expansion valve, an indoor heat exchanger, and a plurality of refrigerant pipes connecting the above units to form a closed circuit. The air conditioner forms a refrigerating cycle, and cools and heats an indoor space using endothermic and exothermic reactions, which are carried out when a refrigerant circulating in the closed circuit is evaporated or liquefied in the indoor and outdoor heat exchangers.

The above units forming the refrigerating cycle of the air conditioner are controlled in such a manner that the indoor space is maintained at a predetermined temperature by sensing an indoor temperature and the temperature of the refrigerant flowing in the indoor and outdoor heat exchangers. Thus, a temperature sensor for sensing the temperature of the refrigerant is installed at some refrigerant pipes.

Japanese Patent Laid-open Publication No. H07-225068 discloses a temperature sensor fixing apparatus for installing a temperature sensor in a refrigerant pipe.

The above conventional temperature sensor fixing apparatus includes a mount for holding a refrigerant tube and a holder for holding a temperature sensor, which are formed integrally with each other. The temperature sensor fixing apparatus is fixed to the refrigerant tube by the elastic force of the mount.

The conventional temperature sensor fixing apparatus is fixed to the refrigerant tube only by the elastic force of the mount so as to support the temperature sensor. Thus, when vibration generated from the operation of a compressor is continuously applied to the temperature sensor fixing apparatus, the elastic force of the mount is weakened, thus causing the separation of the temperature sensor fixing apparatus from the refrigerant tube.

Further, the conventional temperature sensor fixing apparatus has a complicated shape, thus causing a difficulty in its manufacturing.

In an effort for solving the above problems, a conventional temperature sensor fixing apparatus has been introduced.

However, the above temperature sensor fixing apparatus requires an operation of bending a grip formed at a fixing area so that a fixing member cannot be separated from a sensor holder after the fixing member is inserted into the sensor holder. A space required to bend the grip at a region where a refrigerant tube is complicated is narrow. Thus, the temperature sensor fixing apparatus is disadvantageous in that it is difficult to bend the grip at this region.

Furthermore, the above temperature sensor fixing apparatus requires a separate fixing member for fixing the temperature sensor, thus increasing component costs. This temperature sensor fixing apparatus reduces the efficiency in installing the temperature sensor.

### SUMMARY OF THE INVENTION

The present general inventive concept provides a temperature sensor fixing apparatus, which stably fixes a temperature sensor in an installed position even when impact or vibration is applied thereto, and an air conditioner having the same.

The present general inventive concept also provides a temperature sensor fixing apparatus having a simple structure so as to reduce the production costs of the apparatus, and an air conditioner having the same.

The present general inventive concept also provides a temperature sensor fixing apparatus, which may easily install a temperature sensor even at a region where a refrigerant pipe is complicated, and an air conditioner having the same.

The present general inventive concept also provides a temperature sensor fixing apparatus, which stably fixes a temperature sensor in an installed position without a separate fixing member, and an air conditioner having the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a temperature sensor fixing apparatus including a sensor holder to hold a temperature sensor, and a fixing member inserted into the sensor holder to fix the temperature sensor to the sensor holder, wherein the fixing member includes a first fixing portion to prevent the fixing member from being separated from the sensor holder in an insertion direction of the fixing member, a contact portion to attach the temperature sensor to the sensor holder, and a second fixing portion elastically deformed when it is inserted into the sensor holder, and elastically restored to its original state when it is protruded from the sensor holder, to prevent the fixing member from being separated from the sensor holder in a direction opposite to the insertion direction.

The fixing member may be made of a plate, the second fixing portion may be provided with an elastic piece including a fixed terminal formed integrally with the plate and an elastically deformed free terminal, obtained by cutting a portion of the plate, and the elastic piece may be bent at a designated angle with the plate.

The length from one end of the first fixing portion to the free terminal may be longer than the length of the sensor holder.

The sensor holder may be provided with a through hole formed by cutting one end of the sensor holder to a designated length so that the elastic piece may be elastically restored to its original state before the free terminal passes through the end of the sensor holder and the free terminal may be protruded outwardly from the outer surface of the sensor holder.

A grip portion to rotate the fixing member in the circumferential direction of the sensor holder may be formed on the first fixing portion.

The contact portion may be bent so that one surface of the central portion of the plate is convex.

The sensor holder includes a cylindrical portion having a designated diameter, and a flare portion expanded outwardly from one end of the cylindrical portion, the first fixing portion including at least one bending portion for forming a space for receiving the flare portion, and at least one of the at least one bending portion presses the outer surface of the cylindrical portion when the flare portion is received in the space.

The temperature sensor includes a sensing member and a wire connected to the sensing member, and the first fixing portion includes a ring-shaped member including an opening to allow the wire to enter the ring-shaped member therethrough, and a reception portion to receive a part of the temperature sensor so as to prevent the temperature sensor from separating from the sensor holder when the temperature sensor is inserted into the sensor holder.

The temperature sensor further includes a protective member including a main body surrounding a part of the sensing member and a terminal having a stepped portion against the main body and surrounding the wire, and the terminal of the protective member may be fixedly received in the reception portion.

The foregoing and/or other aspects and utilities of the present general inventive concept may also be achieved by providing a temperature sensor fixing apparatus including a sensor holder integrally connected to a refrigerant pipe to hold a temperature sensor, and a fixing member inserted into the sensor holder to fix the temperature sensor to the sensor holder, wherein the fixing member includes a first fixing portion to prevent the fixing member from being separated from the sensor holder in an insertion direction of the fixing member, a contact portion to attach the temperature sensor to the sensor holder, and a second fixing portion to prevent the fixing member from separating from the sensor holder in a direction opposite to the insertion direction.

The fixing member may be made of a plate, and the second fixing portion includes a fixing piece obtained by bending one end of the plate at an angle of more than 90 degrees.

The foregoing and/or other aspects and utilities of the present general inventive concept may also be achieved by providing a temperature sensor fixing apparatus including a sensor holder integrally connected to a refrigerant pipe to hold a temperature sensor, a first fixing portion installed to the temperature sensor to prevent the temperature sensor from separating from the sensor holder in an insertion direction of the temperature sensor, and a second fixing portion formed integrally with the temperature sensor to prevent the temperature sensor from being separated from the sensor holder in a direction opposite to the insertion direction.

The temperature sensor includes a sensing member, a wire connected to the sensing member, and a protective tube surrounding one end of the sensing member, and the first fixing portion may be formed by causing the protective tube to be caught by one end of the sensor holder when the temperature sensor is inserted into the sensor holder.

An extension piece may be extended from one end of the temperature sensor, and the second fixing portion may be formed by bending the extension piece such that the extension piece may protrude from the sensor holder and may contact the outer surface of the sensor holder when the temperature sensor is inserted into the sensor holder.

The foregoing and/or other aspects and utilities of the present general inventive concept may also be achieved by providing an air conditioner including refrigerant pipes, and a temperature sensor fixing apparatus to install a temperature sensor in a refrigerant pipe, the refrigerant pipe including a sensor holder integrally connected to the outer surface of the refrigerant pipe, and a fixing member inserted into the sensor holder, wherein the fixing member includes a first fixing portion to prevent the fixing member from being separated from the sensor holder in an insertion direction of the fixing member, a contact portion extended from the first fixing portion and bent for elastically supporting the temperature sensor so that the temperature sensor adheres to the sensor holder, and a second fixing portion provided with an elastic piece extended from the contact portion, elastically deformed when it is inserted into the sensor holder, and elastically restored to its original state when it protrudes from the sensor holder to prevent the fixing member from being separated from the sensor holder in a direction opposite to the insertion direction.

The fixing member may be made of a plate having a small thickness, the elastic piece includes a fixed terminal formed integrally with the plate and an elastically deformed free terminal, obtained by cutting a portion of the plate, which may be bent at a designated angle with the plate, and the free terminal may be formed in a direction facing the first fixing portion.

The foregoing and/or other aspects and utilities of the present general inventive concept may also be achieved by providing a temperature sensor unit, including a sensor holder a sensing member to be held by the sensor holder, and having a wire extended from one end thereof a fixing member to fix the sensing member to the sensor holder, and having a fixing position extended from one end thereof, to receive the wire of the sensing member.

The fixing portion of the fixing member may include a ring-shaped member to surround the wire and an opening formed on a portion of the ring-shaped member to provide a passage such that the wire passes through the opening to be disposed into the ring-shaped member.

The fixing member may also include another fixing portion formed on the other end thereof to prevent the fixing member from being separated from the sensor holder.

The foregoing and/or other aspects and utilities of the present general inventive concept may also be achieved by providing a temperature sensor fixing unit, including a sensor holder having a cylindrical portion, an end found on a first end of the cylindrical portion, and a flare portion found on a second end of the cylindrical portion, a temperature sensor having a sensing member, a wire extended from the sensing member, and a protective tube found between the sensing member and the wire to be disposed into the flare portion, and a fixing member having a contact portion disposed between the cylindrical portion and the sensing member, a first fixing portion to surround the flare portion, and a second portion to surround the end of the sensor holder.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view illustrating a temperature sensor fixing apparatus, according to an embodiment of the present general inventive concept;

FIG. 2 is a cross-sectional view illustrating an insertion of a temperature sensor and a fixing member into a sensor holder in the temperature sensor fixing apparatus of FIG. 1;

FIG. 3 is an exploded perspective view illustrating a temperature sensor fixing apparatus, according to another embodiment of the present general inventive concept;

FIG. 4 is a cross-sectional view illustrating an insertion of a temperature sensor and a fixing member into a sensor holder in the temperature sensor fixing apparatus of FIG. 3;

FIG. 5 is an exploded perspective view illustrating a temperature sensor fixing apparatus according to another embodiment of the present general inventive concept;

FIG. 6 is a cross-sectional view illustrating an insertion of a temperature sensor and a fixing member into a sensor holder in the temperature sensor fixing apparatus of FIG. 5;

FIG. 7 is an exploded perspective view illustrating a temperature sensor fixing apparatus according to another embodiment of the present general inventive concept;

FIG. 8 is a cross-sectional view illustrating an insertion of a temperature sensor and a fixing member into a sensor holder in the temperature sensor fixing apparatus of FIG. 7;

FIG. 9 is an exploded perspective view illustrating a temperature sensor fixing apparatus according to another embodiment of the present general inventive concept;

FIG. 10 is a cross-sectional view illustrating an insertion of a temperature sensor into a sensor holder in the temperature sensor fixing apparatus of FIG. 9; and

FIG. 11 is a plan view illustrating an outdoor unit of an air conditioner including a temperature sensor fixing apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

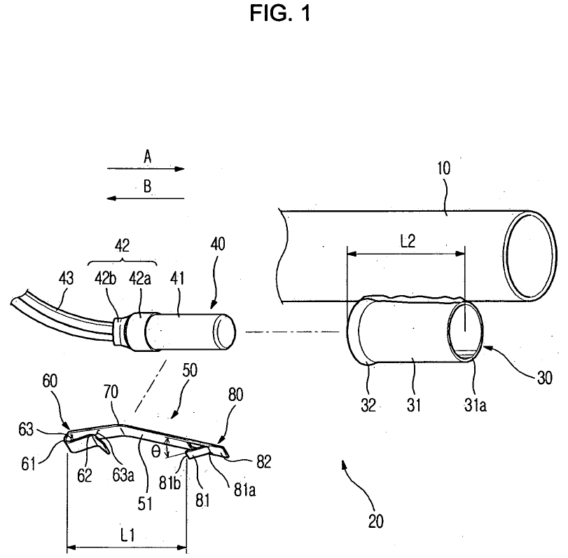

FIG. 1 is an exploded perspective view illustrating a temperature sensor fixing apparatus 20 in accordance with an embodiment of the present general inventive concept.

Referring to FIG. 1, the temperature sensor fixing apparatus 20 may include a sensor holder 30 connected to a refrigerant pipe 10 (or another pipe used for various purposes), the temperature of which may be measured, and a fixing member 50 inserted into the sensor holder 30 to fix a temperature sensor 40, so that the temperature sensor 40 cannot be separated from the sensor holder 30.

The sensor holder 30 has a cylindrical tubular structure having a designated length, and may be connected to the refrigerant pipe 10 by welding, thus being integrated with the refrigerant pipe 10. The sensor holder 30 may be connected to the refrigerant pipe 10 by other methods.

The sensor holder 30 is made of the same metal as the refrigerant pipe 10, such as copper, so that the temperature sensor 40 can measure the temperature of a fluid flowing in the refrigerant pipe 10. However, other materials that perform the intended operations of the present general inventive concept may be used alternatively. The sensor holder 30 may include a cylindrical portion 31 having a uniform diameter with an end 31a, and a flare portion 32 expanded outwardly from one end of the cylindrical portion 31.

The flare portion 32 indicates an insertion direction of the temperature sensor 40 and the fixing member 50 into the sensor holder 30. Simultaneously, the flare portion 32 serves as a stopper, which may catch one end of the fixing member 50 when the fixing member 50 is inserted into the sensor holder 30, thereby preventing the fixing member 50 from further moving in the insertion direction.

The temperature sensor 40 is inserted into the sensor holder 30, thus sensing the temperature of a refrigerant. The temperature sensor 40 includes a sensing member 41 having a cylindrical shape and sensing the temperature of the refrigerant pipe 10, which is transferred through the sensor holder 30, a protective tube 42 surrounding one end of the sensing member 41, and a wire 43 connected to the sensing member 41 through the protective tube 42.

The protective tube 42 is made of a nonconductive material. However, other materials that perform the intended operations of the present general inventive concept may be used alternatively. The protective tube 42 includes a main body 42a surrounding the end of the sensing member 41, and a terminal 42b having a stepped portion against the main body 42a and surrounding the wire 43. The terminal 42b of the protective tube 42 surrounds the wire 43, thus preventing moisture from penetrating into the protective tube 42.

The fixing member 50, which is inserted into the sensor holder 30 together with the insertion of the temperature sensor 40, is made of a metal plate 51 having a small thickness. Thus, the fixing member 50 can be elastically deformed.

The fixing member 50 includes a first fixing portion 60 to prevent the fixing member 50 from being separated from the sensor holder 30 in the insertion direction of the fixing member 50 (hereinafter, referred to “an A direction”), a contact portion 70 to cause the temperature sensor 40 to contact the sensor holder 30, and a second fixing portion 80 to prevent the fixing member 50 from being separated from the sensor holder 30 in a direction opposite to the insertion direction (hereinafter, referred to “a B direction”).

The first fixing portion 60 includes a plurality of bending portions 61 and 62, which are obtained by bending the plate 51 a plurality of times, so as to form a space 63, into which the flare portion 32 of the sensor holder 30 is inserted. The first bending portion 61 may serve as a support, which may be opposite to an entrance portion 63a of the space 63 to elastically widen the entrance portion 63a, and the second bending portion 62 is extended from the first bending portion 61 to form the entrance portion 63a together with the plate 51 to receive a flare portion 32.

The contact portion 70 is bent so that one surface of the central portion of the plate 51 is convex.

The second fixing portion 80 includes an elastic piece 81. The elastic piece 81 is elastically deformed in a direction, which intersects the A and B directions, so that the fixing member 50 can be inserted into the sensor holder 30 in the A direction, and the fixing member 50 cannot be separated from the sensor holder 30 in the B direction after the fixing member 50 has been inserted into the sensor holder 30.

The elastic piece 81 is formed integrally with the plate 51 by cutting an edge of a portion of the plate 51 except for one end thereof. The end of the portion of the plate 51, which is not cut, is referred to as a fixed terminal 81a, and the other end of the portion of the plate 51, which is cut, is referred to as a free terminal 81b, which may be elastically deformed against the fixed terminal 81a.

The free terminal 81b is formed in a direction facing the first fixing portion 60, such that the end 31a is inserted between the plate 51 and the plastic piece 81.

The elastic piece 81 is bent at a designated angle (θ) with the plate 51. The length (L1) from the first bending portion 61 of the first fixing portion 60 to the free terminal 81b may be longer than the length (L2) of the sensor holder 30.

A guide portion 82 is formed on one distal end of the plate 51, that is, is extended from the elastic piece 81 toward the one distal end of the plate. The guide portion 82 may be extended from the fixed terminal 81a, and guides the fixing member 50 to the inside of the sensor holder 30 so that the fixing member 50 can be easily inserted into the sensor holder 30 together with the insertion of the temperature sensor 40.

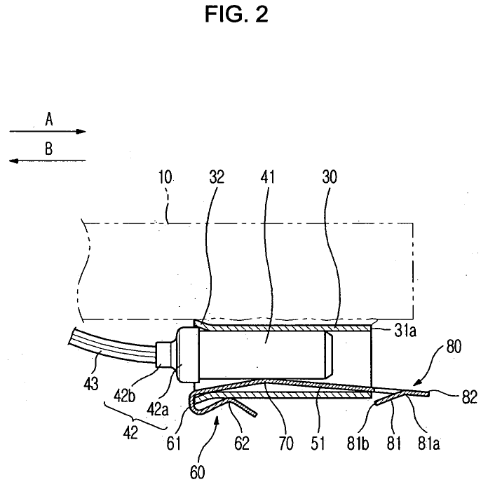

FIG. 2 is a cross-sectional view illustrating an insertion of the temperature sensor 40 and the fixing member 50 into the sensor holder 30, according to the embodiment of FIG. 1.

In order to insert the temperature sensor 40 into the sensor holder 30, the sensing member 41 is attached to the fixing member 50 so that the first bending portion 61 of the fixing member 50 and the main body 42a of the protective tube 42 are located on the same line. Thereafter, the temperature sensor 40 and the fixing member 50 are inserted into the sensor holder 30. As described above, the temperature sensor 40 and the fixing member 50 are inserted into the sensor holder 30 through the flare portion 32.

When the temperature sensor 40 and the fixing member 50 are pushed into the sensor holder 30, the temperature sensor 40 and the fixing member 50 are guided by the guide portion 82, and the second fixing portion 80 is inserted into the sensor holder 30. When the second fixing portion 80 is inserted into the sensor holder 30, the free terminal 81b contacts the inner surface of the sensor holder 30. Then, the elastic pin 81 is elastically deformed against the fixed terminal 81a, and a portion of the plate 51 between the contact portion 70 and the second fixing portion 80 is elastically deformed.

When the temperature sensor 40 and the fixing member 50 are more deeply pushed into the sensor holder 30 under the above state, the temperature sensor 40 and the fixing member 50 are completely inserted into the sensor holder 30. Thereby, the free terminal 81b passes through the end 31a of the cylindrical portion 31, and the elastic piece 81 is elastically restored to its original state against the fixed terminal 81a. When the elastic piece 81 is restored to its original state, the free terminal 81b protrudes outwardly from the outer surface of the cylindrical portion 31.

The flare portion 32 is inserted into the space 63 formed in the first fixing portion 60 through the entrance portion 63a. When the flare portion 32 passes through the entrance portion 63a, the second bending portion 62 is elastically deformed against the first bending portion 61, and thus the entrance portion 63a is widened. Thereby, the flare portion 32 can pass through the entrance portion 63a. After the flare portion 32 has passed through the entrance portion 63a, the second bending portion 62 is elastically restored to its original state, and thus the entrance portion 63a is narrowed and the second bending portion 62 presses the outer surface of the sensor holder 30. Accordingly, the flare portion 32, which has been inserted into the space 63, cannot be easily separated from the space 63.

When the main body 42a of the protective tube 42 is caught by the flare portion 32, the temperature sensor 40 cannot move in the A direction any more. Furthermore, when the contact portion 70 pushes the temperature sensor 40 in the radial direction of the sensor holder 30, the temperature sensor 40 is fixed in the sensor holder 30.

When force is applied to the temperature sensor 40 and the fixing member 50 under the condition that the temperature sensor 40 and the fixing member 50 are fixedly inserted into the sensor holder 30, the fixing member 50 can move to a designated distance in the B direction. When the elastic piece 81 is caught by the end 31a of the cylindrical portion 31 as the fixing member 50 moves in the B direction, the fixing member 50 and the temperature sensor 40 may not be separated from the sensor holder 30.

The embodiment of FIG. 1 illustrates the temperature sensor 40 and the fixing member 50, which are simultaneously inserted into the sensor holder 30. However, one of the temperature sensor 40 and the fixing member 50 may be first inserted into the sensor holder 30, and the other one of the temperature sensor 40 and the fixing member 50 may be later inserted into the sensor holder 30.

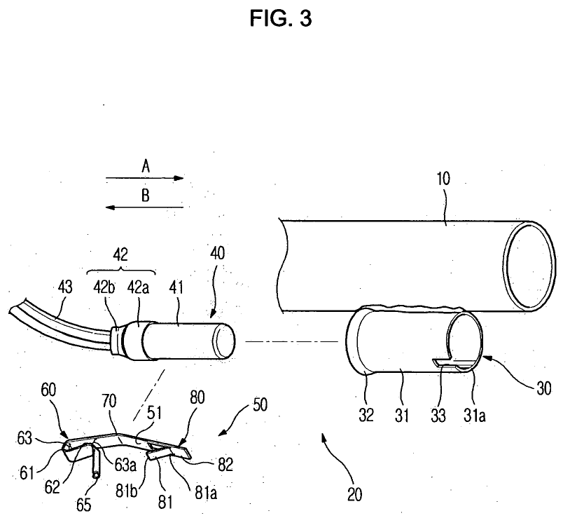

FIG. 3 is an exploded perspective view illustrating a temperature sensor fixing apparatus in accordance with another embodiment of the present general inventive concept. Elements of the temperature sensor fixing apparatus of the embodiment of FIG. 3, which are the same as or similar to those of the temperature sensor fixing apparatus of the embodiment of FIG. 1, are denoted by same reference numerals, and a detailed description thereof will be thus omitted.

Referring to FIG. 3, a temperature sensor fixing apparatus 20 includes a sensor holder 30. The sensor holder 30 includes a cylindrical portion 31, and a through hole (cut out portion) 33 formed through the cylindrical portion 31. The through hole 33 may have a designated length and may be formed by cutting an end 31a of the cylindrical portion 31.

A length between a contact portion 70 and a guide portion 82 of a fixing member 50 in the embodiment of FIG. 3 may be shorter than that in the embodiment of FIG. 1, so that an elastic piece 81 may be elastically restored to its original state through the through hole 33 when the fixing member 50 is completely inserted into the sensor holder 30.

A grip portion 65 may be extended from a second bending portion 62 and may be formed on a first fixing portion 60. The grip portion 65 may be extended from the second bending portion 62 in a direction intersecting the surface of a plate 51, and may then be rolled. A length of the fixing member 50 of FIG. 3 may be shorter than or equal to a length of the fixing member 50 of FIG. 1, since the free terminal 81b can be disposed in the through hole 33.

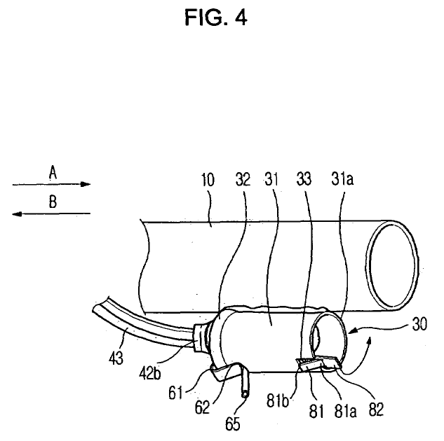

FIG. 4 is a cross-sectional view illustrating an insertion of a temperature sensor and a fixing member into a sensor holder, according to the embodiment of FIG. 3.

When the temperature sensor 40 and the fixing member 50 are completely inserted into the sensor holder 30, as illustrated in FIG. 4, the elastic piece 81 of the fixing member 50 may be elastically restored to its original state through the through hole 33. Thereby, the free terminal 81b may protrude outwardly from the outer surface of the cylindrical portion 31.

When the grip portion 65 is pushed in a circumferential direction of the sensor holder 30 under the above state, the fixing member 50 may be rotated in the circumferential direction of the sensor holder 30. Thereby, the elastic piece 81 may be separated from the through hole 33, and the end 31a of the cylindrical portion 31 may be interposed between the plate 51 and the elastic piece 81.

In the above state, the fixing member 50 cannot move in the A and B directions. Accordingly, the temperature sensor fixing apparatus 20 of the embodiment of FIG. 3 can more stably fix the temperature sensor 40 and the fixing member 50, as compared to the temperature sensor fixing apparatus 20 of the embodiment of FIG. 1.

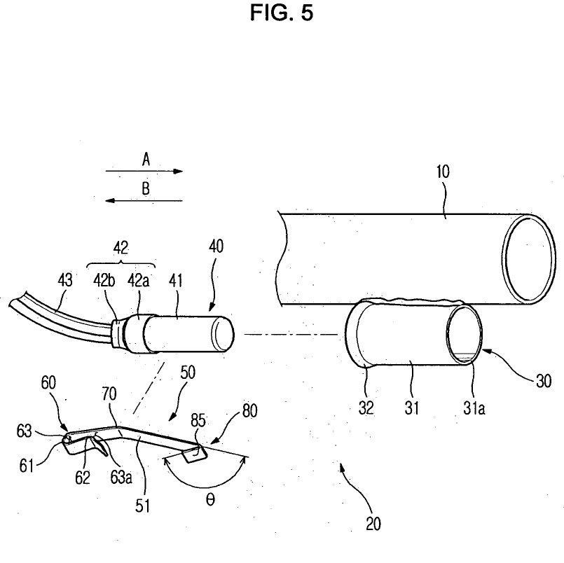

FIG. 5 is an exploded perspective view illustrating a temperature sensor fixing apparatus 20 in accordance with another embodiment of the present general inventive concept. Elements of the temperature sensor fixing apparatus of the embodiment of FIG. 5, which are the same as or similar to those of the temperature sensor fixing apparatus 20 of the embodiments of FIGS. 1 and 3, are denoted by same reference numerals, and a detailed description thereof will be thus omitted.

As illustrated in FIG. 5, the temperature sensor fixing apparatus 20 of the embodiment of FIG. 5 may include a fixing member 50 including a second fixing portion 80 provided with a fixing piece 85. The fixing piece 85 may be obtained by bending one end of a plate 51 at an angle of more than 90 degrees.

Since the fixing piece 85 may be obtained only by bending one end of the plate 51, the fixing piece 85 may be more easily manufactured, compared to an elastic piece 81 of the temperature sensor fixing apparatus 20 of the embodiment of FIG. 1.

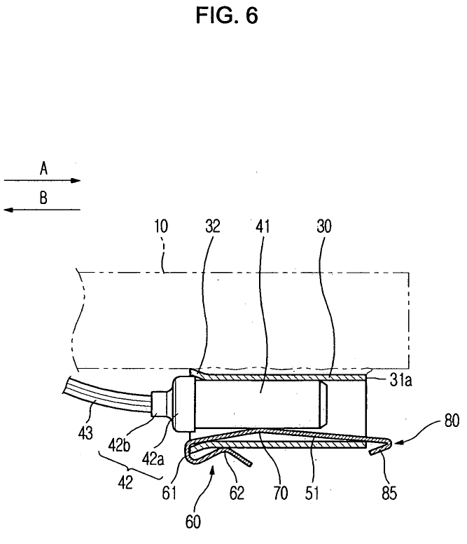

FIG. 6 illustrates an insertion of a temperature sensor 40 in the refrigerant pipe 10 using the temperature sensor fixing apparatus 20 of the embodiment of FIG. 5.

The temperature sensor fixing apparatus 20 of the embodiment of FIG. 5 does not have a guide portion 82 formed on the fixing member 50. Further, the fixing piece 85 of the embodiment of FIG. 5 may be elastically less deformed than the elastic piece 81 of the embodiment of FIG. 1. Accordingly, when the temperature sensor 40 is installed in the refrigerant pipe 10 using the temperature sensor fixing apparatus 20 of the embodiment of FIG. 5, the fixing member 50 may be first inserted into a sensor holder 30, and the temperature sensor 40 may be then inserted into the sensor holder 30.

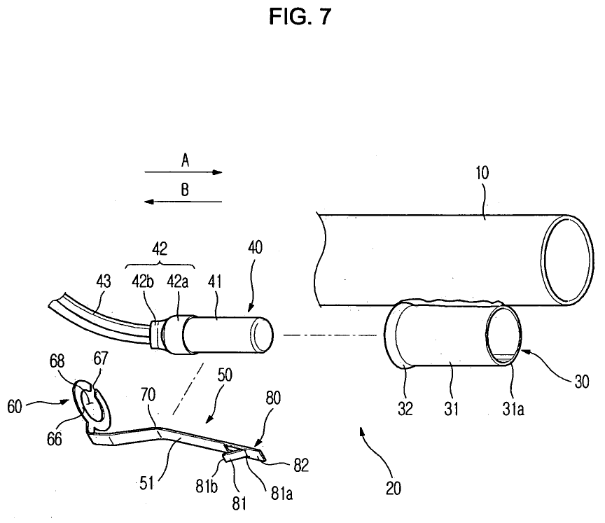

FIG. 7 is an exploded perspective view illustrating a temperature sensor fixing apparatus 20 in accordance with another embodiment of the present general inventive concept.

As illustrated in FIG. 7, the temperature sensor fixing apparatus 20 of the fourth embodiment includes a fixing member 50 including a first fixing portion 60 having a ring-shaped member 66.

The ring-shaped member 66 includes an opening 67 for allowing a wire 43 of a temperature sensor 40 to enter the ring-shaped member 66 therethrough, and a reception portion 68, into which a terminal 42b of a protective tube 42 is inserted.

The width of the opening 67 may be larger than that of the thickness of the wire 43, and the diameter of the reception portion 68 may be equal to the diameter of the terminal 42b of the protective tube 42, so that the terminal 42b of the protective tube 42 may be inserted into the ring-shaped member 66.

Referring to FIG. 7, a process for installing a temperature sensor 40 using the temperature sensor fixing apparatus 20 will be described.

After the wire 43 of the temperature sensor 40 has passed through the opening 67, the wire 43 may be pulled. Thereby, the terminal 42b of the protective tube 42 may be fixedly inserted into the reception portion 68, and the temperature sensor 40 may be thus fixed to the ring-shaped member 66.

Under the state in which the temperature sensor 40 is fixed to the ring-shaped member 66, the contact between a sensing member 41 of the temperature sensor 40 and the contact portion 70 of the fixing member 50 may be maintained.

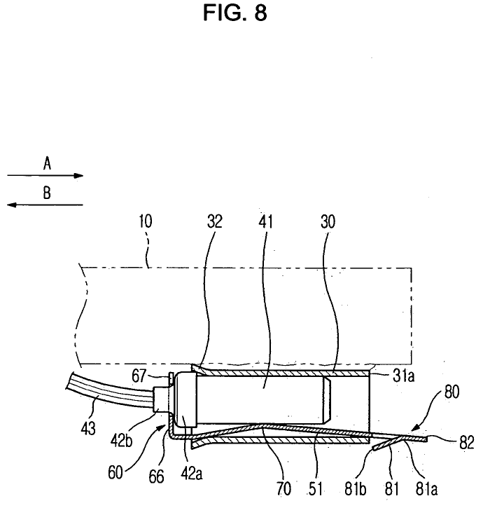

When the fixing member 50 is inserted into a sensor holder 30 under the condition that the temperature sensor 40 is fixed to the fixing member 50, as illustrated in FIG. 8, terminal 42a of the protective tube 42 may be caught by a flare portion 32 of the sensor holder 30. Accordingly, the temperature sensor 40 cannot move in an A direction any more. Furthermore, when a contact portion 70 pushes the temperature sensor 40 in a radial direction of the sensor holder 30, the temperature sensor 40 may be fixed in the sensor holder 30.

When the fixing member 50 is completely inserted into the sensor holder 30, an elastic piece 81 may be elastically restored to its original state. Thereby, a free terminal 81b protrudes outwardly from the outer surface of a cylindrical portion 31. Accordingly, the movement of the temperature sensor 40 and the fixing member 50 in a B direction may be restricted.

Furthermore, since the main body 42b of the protective tube 42 is caught by the ring-shaped member 66, the movement of the temperature sensor 40 in the B direction is restricted. Accordingly, it may be possible to prevent the temperature sensor 40 from being separated from the sensor holder 30.

The second fixing portion 80 of the fixing member 50 of the embodiment of FIG. 7 has the same configuration as that of the embodiment of FIG. 1. However, when the second fixing portion 80 of the fixing member 50 of the embodiment of FIG. 7 has the same configuration as that of the embodiment of FIG. 3 and a through hole for passing the elastic piece 81 through may be formed through the sensor holder 30, the temperature sensor 40 and the fixing member 50 cannot move the A and B directions.

As described above, the main body 42a of the protective tube 42 may be caught by the ring-shaped member 66, thus restricting the movement of the temperature sensor 40 in the B direction. However, when the temperature sensor 40 does not have a protective tube, the sensing member 41 may be received in the reception portion 68 of the ring-shaped member 66 so as to restrict the movement of the temperature sensor 40.

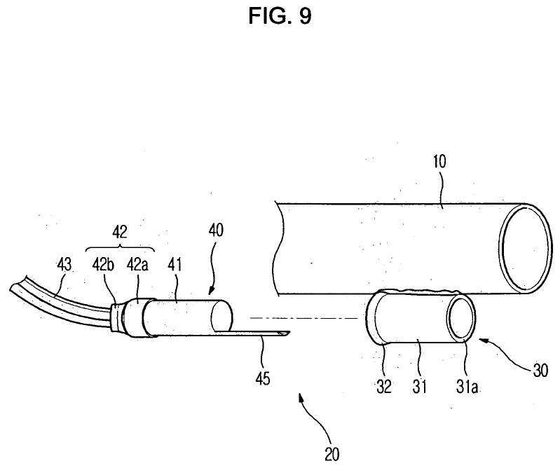

FIG. 9 is an exploded perspective view of a temperature sensor fixing apparatus in accordance with another embodiment of the present general inventive concept.

A temperature sensor fixing apparatus 20 of the embodiment of FIG. 9 does not have a separate fixing member, which may be inserted into a sensor holder 30 together with the insertion of a temperature sensor 40. Instead, the temperature sensor fixing apparatus 20 of the embodiment of FIG. 9 includes an extension piece 45, which may be extended from one end of a sensing member 41 of the temperature sensor 40. The extension piece 45 may be made of a thin plate so that the extension piece 45 can be easily bent. The extension piece 45 may be formed integrally with the sensing member 41 of the temperature sensor 40 by casting.

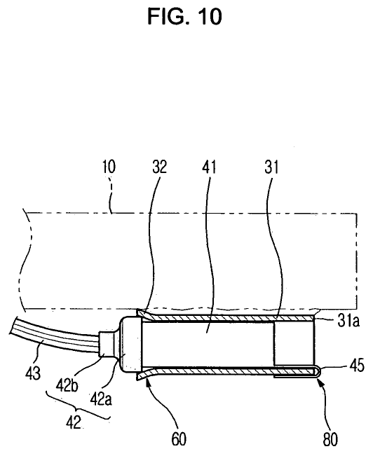

FIG. 10 is a cross-sectional view illustrating an insertion of the temperature sensor 40 into the sensor holder 30 in the temperature sensor fixing apparatus of FIG. 9.

When the temperature sensor 40 is inserted into the sensor holder 30, a main body 42a of a protective tube 42, which surrounds one end of the sensing member 41, may be caught by a flare portion 32 of the sensor holder 30. Accordingly, the temperature sensor 40 can no longer move in the sensor holder 30. Thereby, a first fixing portion 60 may be formed.

Furthermore, when the temperature sensor 40 is inserted into the sensor holder 30, a portion of an extension piece 50 may be protruded from the sensor holder 30.

A portion of the extension piece 50, which may be protruded from the sensor holder 30, may be bent over one end 31a of a cylindrical portion 31, such that the bent portion of the extension piece 50 can contact the outer surface of the sensor holder 30. Thereby, as illustrated in FIG. 10, a second fixing portion 80 to prevent the temperature sensor 40 from being separated from the sensor holder 30 in a direction opposite to an insertion direction may be formed.

When the temperature sensor 40 is fixed to the sensor holder 30 of the above temperature sensor fixing apparatus 20 by bending the extension piece 50 after the temperature sensor 40 is inserted into the sensor holder 30, the temperature sensor 40 is not separated from the sensor holder 30 in the insertion direction of the temperature sensor 40 by the first fixing portion 60 and is not separated from the sensor holder 30 in the direction opposite to the insertion direction by the second fixing portion 80.

The temperature sensor fixing apparatus of the embodiment of FIG. 9 can stably fix the temperature sensor 40 in an installed position without a separate fixing member.

Referring to FIGS. 1-10, FIG. 11 illustrates an outdoor unit 1 of an air conditioner, installed with the temperature sensor fixing apparatus 20 according to the present general inventive concept.

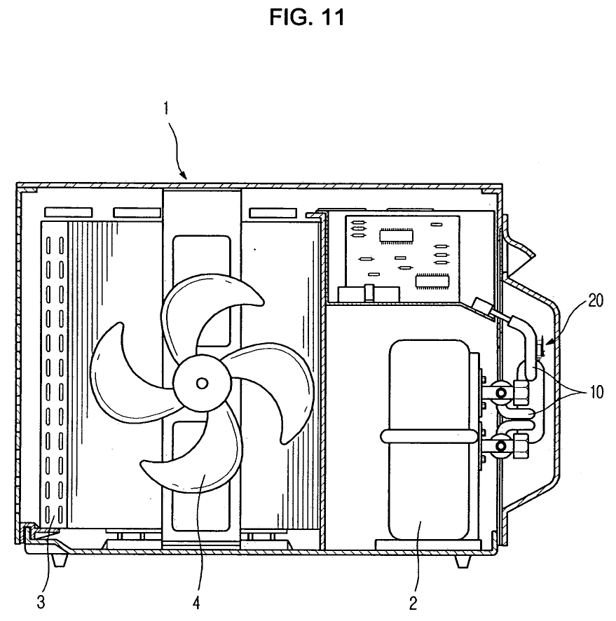

As illustrated in FIG. 11, a compressor 2 to compress a gas refrigerant into a high-temperature and high-pressure state, a condenser 3 to condense the compressed gas refrigerant in the high-temperature and high-pressure state, an air blast fan 4 to forcibly blow external air into the condenser 3 so that the condenser 3 exchanges heat with the external air, and a plurality of refrigerant pipes 10 to connect the compressor 2 and the condenser 3 are installed in an outdoor unit 1 of an air conditioner.

The temperature sensor fixing apparatus 20 of the present embodiment may be installed in the refrigerant pipe 10, the temperature of which is to be measured. The temperature sensor fixing apparatus 20 serves to stably fix the temperature sensor 40. The temperature sensor fixing apparatus 20 of the present embodiment may be installed in elements other than the refrigerant pipe of a system other than the air conditioner, the temperature of which is to be measured.

As apparent from the above description, the present general inventive concept provides a temperature sensor fixing apparatus and an air conditioner having the same, in which a sensor holder may be integrally connected to a refrigerant pipe in a horizontal direction, and a temperature sensor and a fixing member may be supportably inserted into the sensor holder, thereby stably fixing the temperature sensor in an installed position.

The temperature sensor fixing apparatus of the present general inventive concept has a simple structure, thus having reduced production costs.

The temperature sensor fixing apparatus of the present general inventive concept allows the temperature sensor to be easily installed in the refrigerant pipe at a narrow region, thus improving the efficiency of installing the temperature sensor.

The temperature sensor fixing apparatus of the present general inventive concept stably fixes the temperature sensor without a separate fixing member, thus reducing component costs and increasing the efficiency in installing the temperature sensor.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A temperature sensor fixing apparatus comprising:
a sensor holder to hold a temperature sensor; and
a fixing member inserted into the sensor holder to fix the temperature sensor to the sensor holder,
wherein the fixing member comprises;
a first fixing portion to prevent the fixing member from being separated from the sensor holder in an insertion direction of the fixing member,
a contact portion to attach the temperature sensor to the sensor holder, and
a second fixing portion elastically deformed when it is inserted into the sensor holder and elastically restored to its original state when it protrudes from the sensor holder to prevent the fixing member from being separated from the sensor holder in a direction opposite to the insertion direction.

2. The temperature sensor fixing apparatus according to claim 1, wherein:
the fixing member is made of a plate; and
the second fixing portion is provided with an elastic piece comprising;
a fixed terminal is formed integrally with the plate, and
a free terminal, obtained by cutting a portion of the plate to be elastically deformed and to be bent at a designated angle with the plate.

3. The temperature sensor fixing apparatus according to claim 2, wherein a length from one end of the first fixing portion to the free terminal is longer than a length of the sensor holder.

4. The temperature sensor fixing apparatus according to claim 2, wherein:
the sensor holder comprises a through hole formed by cutting one end of the sensor holder to a designated length so that the elastic piece is elastically restored to its original state before the free terminal passes through the end of the sensor holder; and
the free terminal protrudes outwardly from the outer surface of the sensor holder.

5. The temperature sensor fixing apparatus according to claim 4, wherein a grip portion to rotate the fixing member in a circumferential direction of the sensor holder is formed on the first fixing portion.

6. The temperature sensor fixing apparatus according to claim 1, wherein the contact portion is bent so that one surface of a center portion of the plate is convex.

7. The temperature sensor fixing apparatus according to claim 1, wherein:
the sensor holder comprises:
a cylindrical portion having a designated diameter, and
a flare portion expanded outwardly from one end of the cylindrical portion, and
the first fixing portion further comprises;
at least one bending portion to form a space to receive the flare portion, and
at least one of the at least one bending portion presses the outer surface of the cylindrical portion when the flare portion is received in the space.

8. The temperature sensor fixing apparatus according to claim 1, wherein:
the temperature sensor comprises;
a sensing member, and
a wire connected to the sensing member; and
the first fixing portion further comprises;
a ring-shaped member formed with an opening to allow the wire to enter the ring-shaped member therethrough, and
a reception portion to receive a part of the temperature sensor so as to prevent the temperature sensor from being separated from the sensor holder when the temperature sensor is inserted into the sensor holder.

9. The temperature sensor fixing apparatus according to claim 8, wherein the temperature sensor further comprises:
a protective member formed with a main body to surround a part of the sensing member; and
a terminal having a stepped portion against the main body and to surround the wire, the terminal of the protective member being fixedly received in the reception portion.

10. A temperature sensor fixing apparatus comprising:
a sensor holder integrally connected to a refrigerant pipe to hold a temperature sensor; and
a fixing member inserted into the sensor holder to fix the temperature sensor to the sensor holder,
wherein the fixing member comprises;
a first fixing portion to prevent the fixing member from being separated from the sensor holder in an insertion direction of the fixing member,
a contact portion to attach the temperature sensor to the sensor holder, and
a second fixing portion to prevent the fixing member from being separated from the sensor holder in a direction opposite to the insertion direction.

11. The temperature sensor fixing apparatus according to claim 10, wherein:
the fixing member is made of a plate; and
the second fixing portion comprises a fixing piece obtained by bending one end of the plate at an angle of more than 90 degrees.

12. A temperature sensor fixing apparatus comprising:
a sensor holder integrally connected to a refrigerant pipe to hold a temperature sensor;
a first fixing portion installed to the temperature sensor to prevent the temperature sensor from being separated from the sensor holder in an insertion direction of the temperature sensor; and
a second fixing portion formed integrally with the temperature sensor to prevent the temperature sensor from being separated from the sensor holder in a direction opposite to the insertion direction.

13. The temperature sensor fixing apparatus according to claim 12, wherein:
the temperature sensor comprises;
a sensing member,
a wire connected to the sensing member, and
a protective tube surrounding one end of the sensing member; and
the first fixing portion is formed by the protective tube being caught by one end of the sensor holder when the temperature sensor is inserted into the sensor holder.

14. The temperature sensor fixing apparatus according to claim 12, wherein:
an extension piece is extended from one end of the temperature sensor; and
the second fixing portion is formed by bending the extension piece such that the extension piece is protruded from the sensor holder and contacts the outer surface of the sensor holder when the temperature sensor is inserted into the sensor holder.

15. An air conditioner comprising:
refrigerant pipes; and
a temperature sensor fixing apparatus to install a temperature sensor in a refrigerant pipe, the temperature sensor fixing apparatus comprising;
a sensor holder integrally connected to the outer surface of the refrigerant pipe, and
a fixing member inserted into the sensor holder;
wherein the fixing member comprises;
a first fixing portion to prevent the fixing member from being separated from the sensor holder in an insertion direction of the fixing member,
a contact portion extended from the first fixing portion and bent to elastically support the temperature sensor so that the temperature sensor is adhered to the sensor holder, and
a second fixing portion provided with an elastic piece extended from the contact portion, which is elastically deformed when it is inserted into the sensor holder, and is elastically restored to its original state when it is protruded from the sensor holder to prevent the fixing member from being separated from the sensor holder in a direction opposite to the insertion direction.

16. The air conditioner according to claim 15, wherein:
the fixing member is made of a plate having a small thickness;
the elastic piece comprises;
a fixed terminal formed integrally with the plate, and
a free terminal obtained by cutting a portion of the plate, and is bent at a designated angle with the plate to be elastically deformable with respect to the plate, and
the free terminal is formed in a direction facing the first fixing portion.

17. A temperature sensor unit, comprising:
a sensor holder;
a sensing member to be held by the sensor holder, and having a wire extended from one end thereof; and
a fixing member to fix the sensing member to the sensor holder, and having a fixing position extended from one end thereof, to receive the wire of the sensing member.

18. The temperature sensor unit of claim 17, wherein the fixing portion of the fixing member comprises a ring-shaped member to surround the wire and an opening formed on a portion of the ring-shaped member to provide a passage such that the wire passes through the opening to be disposed into the ring-shaped member.

19. The temperature sensor unit of claim 17, wherein the fixing member further comprises another fixing portion formed on the other end thereof to prevent the fixing member from being separated from the sensor holder.

20. A temperature sensor fixing unit, comprising:
a sensor holder having a cylindrical portion, an end found on a first end of the cylindrical portion, and a flare portion found on a second end of the cylindrical portion;
a temperature sensor having a sensing member, a wire extended from the sensing member, and a protective tube found between the sensing member and the wire to be disposed into the flare portion; and
a fixing member having a contact portion disposed between the cylindrical portion and the sensing member, a first fixing portion to surround the flare portion, and a second portion to surround the end of the sensor holder.
